(19) United States
(12) Patent Application Publication
(10) Pub. No.: US 2018/0284588 A1
(43) Pub. Date: Oct. 4, 2018

(54) AUTOFOCUS SYSTEM, PROJECTOR WITH AUTOFOCUS SYSTEM, AND AUTOFOCUS METHOD

(71) Applicant: Coretronic Corporation, Hsin-Chu (TW)

(72) Inventors: Jian-Jiun Wu, Hsin-Chu (TW); Chien-Ming Tsao, Hsin-Chu (TW); Liang-Chieh Weng, Hsin-Chu (TW)

(21) Appl. No.: 15/926,724

(22) Filed: Mar. 20, 2018

(30) Foreign Application Priority Data
Mar. 31, 2017 (CN) 201710207733.6

(51) Int. Cl. G03B 21/53; G02B 7/36

(52) U.S. Cl. CPC G03B 21/53; G02B 7/36

(57) ABSTRACT

An autofocus method for a projector is provided. A projection lens of the projector projects at least projecting one image. The image includes a correction image. The projection lens has a focal length. The autofocus method includes: projecting the correction image; capturing the correction image; capturing a luminance parameter value of the correction image; controlling the focal length of the projection lens according to the luminance parameter value, wherein a process of controlling the focal length of the projection lens according to the luminance parameter value comprises a coarse adjustment phase and a fine adjustment phase, and the luminance parameter value changes with the adjustment of the focal length of the projection lens; and finding a maximum of the luminance parameter value. An autofocus system and a projector having the autofocus system are also provided.

### CROSS-REFERENCE TO RELATED APPLICATION

THIS APPLICATION CLAIMS THE PRIORITY BENEFIT OF CHINA APPLICATION (CN201710207733.6 FILED ON MAR. 31, 2017). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to an autofocus system, and more particularly to an autofocus system and an autofocus method for a projector.

### BACKGROUND OF THE INVENTION

Focusing technology has been used in the field of camera for years; however, focusing technology is relatively less to be further developed in the field of projector. At present, the focusing of projector is primarily realized by measuring the distance between the projector and the projection screen first and then performing the focusing action. In camera focus, the camera's body will not have high heat due to that the camera captures images from the outside and the internal of the camera only receives the images passively. However, in projector focus, the projector projects images out; therefore, the heat generated inside the projector will be directly or indirectly transferred and affects the projection effect of the projection lens.

Projector with autofocus function has a projection lens, a light valve and a lens driver. The image projected by the projector is generated by the light valve disposed in the projector's body; therefore, a lamp is required to generate a light source with a large amount of energy for the projection. The light generated by the light source causes the image generated by the light valve to be projected out from the projector's body through the projection lens, and thereby forming a desired projection screen. A projection lens consisting of lenses has a focal length. When a high-energy light passes through the lenses of the projection lens, thermal expansion and contraction may change the focus effect of the lenses, so that the focal length of the projection lens focal length changes accordingly.

Conventionally, the focus mode of the projector is to measure the position the projection screen. By means of a look-up table, the lens driver finds the corresponding focal-length adjustment value of the projection lens according to the distance and then adjusts the focal length of the projection lens according to the projector and the projection screen. However, the projection lens may be out of focus again once the problem of thermal expansion and contraction occurs. The conventional technology uses more complex look-up table to compensate the problem of thermal expansion and contraction of lenses; however, this means is troublesome and cannot solve the problem fundamentally to solve the problem, so the effect of focusing is not the best.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

One objective of the invention is to provide a projector, an autofocus system disposed in the projector and an autofocus method capable of solving the out-of focus problem caused by lenses having thermal expansion and contraction due to the increased temperature in the conventional projector adopting the distance measuring principle for the autofocus. In addition, the projector of the invention may continuously perform the autofocus during the operation, therefore, the projector will not have out-of-focus no matter the change of temperature and the viewer can get a qualified image.

Further, the problem to be solved by the technique of the invention is the heat drift of the lens caused by heat. That is, the processor calculates the luminance parameter value at the same time as the projector is in operation, and thereby adjusting the position of the projection lens with respect to the projection surface instead of the data calculation only.

Other objectives and advantages of the invention will become apparent from the technical features disclosed in the invention.

In order to achieve one or some or all of the above objectives or other objectives, the invention may relate to an autofocus system disposed in a projector. The projector further includes a projection lens, a light valve and a lens driver. The light valve is adapted to generate at least one image. The projection lens is adapted to project the image. The projection lens has a focal length. The lens driver is adapted to adjust the focal length of the projection lens. The autofocus system includes a processor, an image sensing component and an image signal processor. The processor, electrically connected to the light valve and the lens driver, is adapted to control the light valve to add a correction image into the image. The image sensing component is disposed toward the image and adapted to capture the correction image. The image signal processor, electrically connected to the image sensing component and the processor, is adapted to receive a luminance parameter value of the correction image from the image sensing component. The processor controls the lens driver to adjust the focal length of the projection lens according to the luminance parameter value. The processor adjusts the focal length of the projection lens and changes the luminance parameter value to find a maximum of the luminance parameter value. Once, for example, a maximum luminance contract value is found, it is determined that the focus is successful.

In addition, the invention also relates to a projector, which includes a light valve, a projection lens, a lens driver and an autofocus system. The light valve is adapted to generate at least one image. The projection lens is adapted to project the image and has a focal length. The lens driver is coupled to the projection lens and adapted to adjust the focal length of the projection lens. The autofocus system includes a processor, an image sensing component and an image signal processor.

The processor, electrically connected to the light valve and the lens driver, is adapted to control the light valve to add a correction image into the image. The image sensing component is disposed toward the image and adapted to capture the correction image. The image signal processor, electrically connected to the image sensing component and the processor, is adapted to receive a luminance parameter value of the correction image from the image sensing component. The processor controls the lens driver to adjust the focal length of the projection lens according to the luminance parameter value. The processor adjusts the focal length of the projection lens and changes the luminance parameter value to find a maximum of the luminance parameter value. Once, for example, a maximum luminance parameter value is found, it is determined that the focus is successful.

The invention further relates to an autofocus method for a projector. A projection lens of the projector projects at least one image. The image includes a correction image. The projection lens has a focal length. The autofocus method includes: projecting the correction image; capturing the correction image; receiving a luminance parameter value of the correction image; controlling the focal length of the projection lens according to the luminance parameter value, wherein a process of controlling the focal length of the projection lens according to the luminance parameter value includes a coarse adjustment phase and a fine adjustment phase, and the luminance parameter value changes with the adjustment of the focal length of the projection lens; and finding a maximum of the luminance parameter value.

In summary, since the additionally-disposed image sensing component is employed to capture the correction image in the image, therefore, the projector, the autofocus system in the projector and the autofocus method for the projector of the invention can solve the out-of focus problem caused by lenses having thermal expansion and contraction due to the increased temperature in the conventional projector adopting the distance measuring principle for the autofocus. In addition, since the projector can continuously perform the autofocus during the operation, the projector will not have out-of-focus no matter the change of temperature.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a structure of a projector in accordance with the invention;

FIG. 2 is a schematic view of an operation of the projector in accordance with the invention;

FIG. 3 is a schematic view of a structure of an image sensing component performing a synchronization operation in accordance with the invention;

FIG. 4 is a flow chart of an autofocus in an autofocus method in accordance with the invention when a projector is being turned on; and

FIG. 5 is a flow chart of monitoring out-of-focus and re-focusing in the autofocus method in accordance with the invention after the projector is turned on.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

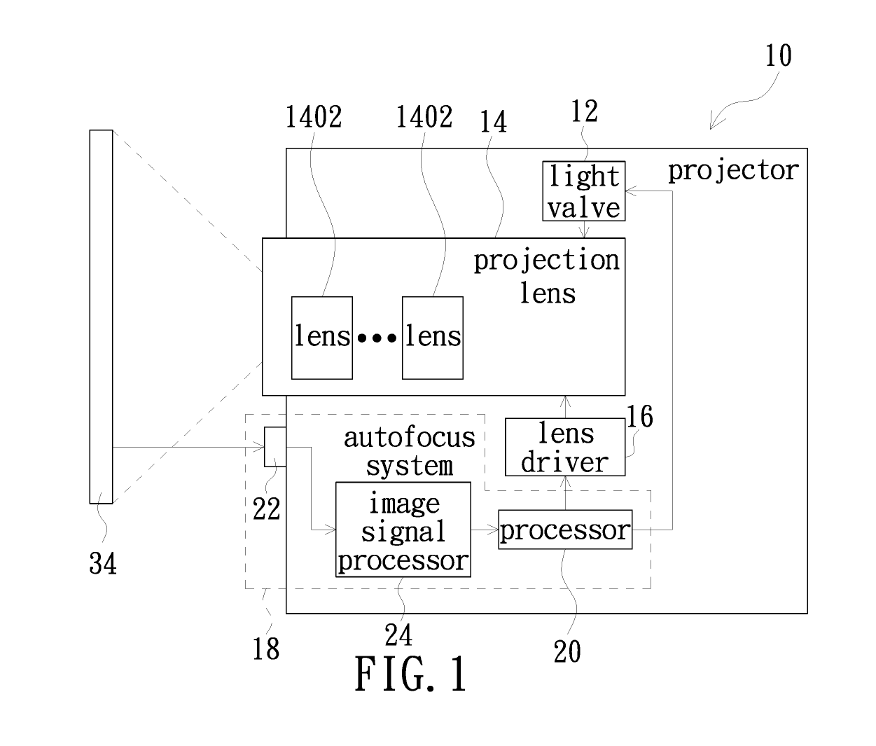

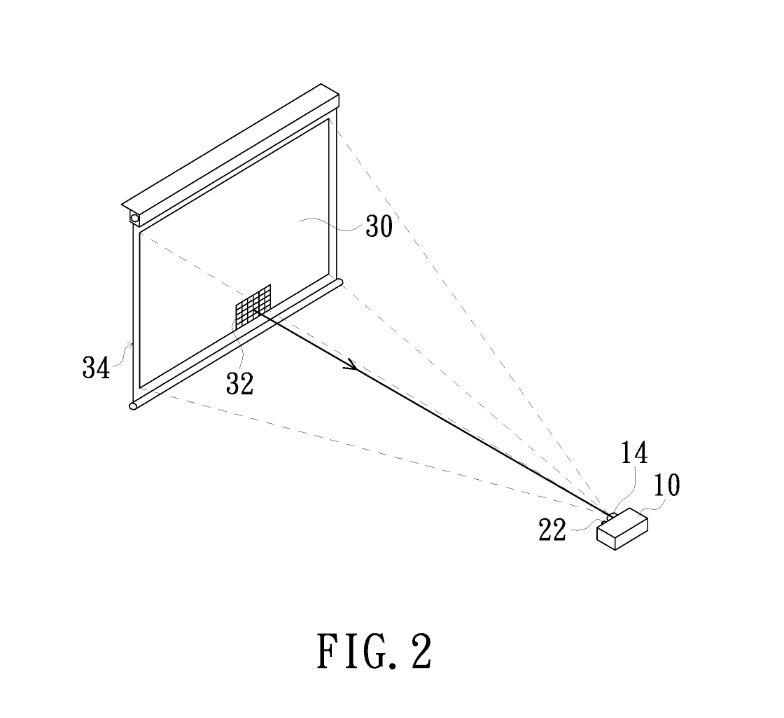

Please refer to FIG. 1 and FIG. 2. FIG. 1 is a schematic view of a structure of a projector in accordance with the invention. FIG. 2 is a schematic view of an operation of the projector in accordance with the invention. The projector 10 of the embodiment includes a light valve 12, a projection lens 14, a lens driver 16 and an autofocus system 18. The light valve 12 is controlled by the processor 20. After receiving an image signal, the processor 20 is configured to control the light valve 12 to generate at least one image 30. In general, a plurality of images 30 is displayed sequentially for viewing by the viewer.

The projection lens 14 includes a plurality of lenses 1402. By means of the principle of the optical imaging of the lenses 1402, the projection lens 14 is adapted to project the image 30 generated by the light valve 12 onto a projection surface 34, wherein the projection surface 34 is on a wall or a projection screen. Since the plurality of lenses 1402 are assembled with each other, the projection lens 14 has a focal length, and therefore, the image 30 can be clearly imaged on the projection surface 34 by adjusting the focal length of the projection lens 14. Herein the adjustment of the focal length of the projection lens 14 is defined as: adjusting the distance between the projection lens 14 and the projection surface 34 to substantially identical with the effective focal length of the projection lens 14 at the time when the projection lens 14 was designed. The lens driver 16 is, for example, a stepping motor, but the invention is not limited thereto. The lens driver 16 is coupled to the projection lens 14 and configured to adjust the distance between the lenses 1402 (or the entire projection lens 14) and the projection surface 34, thereby adjusting the focal length of the projection lens 14. In generally, the focal length is adjusted by simply moving the projection lens 14. The autofocus system 18 is adapted to control the lens driver 16 to adjust the focal length of the projection lens 14. When the focal length of the projection lens 14 is adjusted to the most appropriate, it indicates that the image 30 projected on the projection surface 34 is the clearest.

The autofocus system 18 includes the processor 20, an image sensing component 22 and an image signal processor 24. Please continue to refer to FIGS. 1 and 2. The processor 20 is electrically connected to the light valve 12 and the lens driver 16. The processor 20 is adapted to control the light valve 12 to additionally add a correction image 32 into the image 30, and then the image 30 and the correction image 32 are together imaged on the projection surface 34 by the projection lens 14. The display size of the correction image 32 is smaller than the image 30, so that the viewer is prevented from being interfered by the correction image 32 while viewing the image 30. In addition, a correction image 32 may be inserted into a plurality of images 30 each interval of a certain number of images 30. For example, in a 60 Hz display mode, it is indicated that 60 images 30 may appear in one second and only one of the 60 images 30 is inserted with the correction image 32 or one of the 60 images 30 is superimposed with the correction image 32. Therefore, the viewer will not perceive the appearance of the correction image 32.

The image sensing component 22 may be mounted on the front surface of a housing of the projector 10 or may be built in the projector 10. The image sensing component 22 may adopt, for example, a complementary metal-oxide semiconductor (CMOS) sensor or a camera used in this field and may be integrated with a sensing circuit. The image sensing component 22 is adapted to provide a luminance parameter value for converting an optical signal into an electrical signal. The image sensing component 22 is disposed towards the projection surface 34 and adapted to capture the correction image 32 on the projection surface 34. In the other words, the image signal processor 24 is adapted to receive the luminance parameter value of the correction image 32 from the image sensing component 22. When a CMOS sensor is adopted, the light projected by the projector 10 is very bright (that is, the correction image 32 is very bright), therefore, it is practical to use a CMOS sensor with a sensitivity of ISO 400 or higher; however, the invention is not limited thereto.

The image signal processor 24 is electrically connected to the image sensing component 22 and the processor 20. The image signal processor 24 is adapted to receive the luminance parameter value provided by the image sensing component 22. Specifically, the luminance parameter value is derived from the correction image 32 captured by the image sensing component 22. The image signal processor 24 captures a luminance contract value of the correction image 32. More specifically, the image signal processor 24 appropriately generates a luminance contract value corresponding to the luminance parameter value by a calculation method, but the invention is not limited thereto. In the embodiment, the luminance contract value may be obtained, for example, according to ISO/IEC2118, the contrast determination method or the image clarity method used in this field, but the invention is not limited thereto. For example, the luminance contract value may be calculated by dividing the maximum luminance value of the correction image 32 from the minimum luminance value, wherein the maximum luminance value is from the illuminance at the blank part of the correction image 32 and the minimum luminance value is from the line part of the correction image 32, as shown in FIG. 2. When the luminance contrast value is at a maximum value, it is indicated that the correct image 32 currently is at the clearest state, and accordingly the image 30 is at the clearest state. The image signal processor 24 is, for example, a video processing chip, an image processing chip or an image processing circuit for processing the luminance parameter value from the image sensing component 22. The correction image 32 may be an image having a square pattern or a stripe pattern with black and white colors, but the invention is not limited thereto.

After receiving the luminance contrast value provided by the image signal processor 24, the processor 20 is adapted to control the lens driver 16 to adjust the forward or backward movement of the projection lens 14 according to the luminance contrast value, thereby changing the focal length of the projection lens 14. According to the embodiment of the above-described luminance contrast value, the luminance contrast value changes with the adjustment of the focal length of the projection lens 14; therefore, when the maximum luminance contrast value is found, it is indicated that the focus of the projection lens 14 is successful and the image 30 is the clearest state. Specifically, the processor 20 receives the luminance contrast value from the image signal processor 24 and compares the current luminance contrast value with the previously-received luminance contrast value to approximate the maximum luminance contrast value corresponding to the image 30 in the clearest state. In addition, the processor 20 may include, for example, a central processing unit (CPU), a microprocessor, a scalar of image size, a digital signal processor (DSP), a programmable controller, a programmable logic device (PLD) or the like, or a combination thereof, but the invention is not limited thereto. In an embodiment, the processor 20 further includes a memory (not shown), such as a random access memory (RAM), a read-only memory (ROM) or a hard disk drive (HDD) for storing the luminance contrast value provided from the image signal processor 24, the maximum luminance contrast value generated by an automatic correction procedure or a threshold, but the invention is not limited thereto.

Once the focal length of the projection lens 14 is determined by the processor 20, the processor 20 stops controlling the lens driver 16; however, the image sensing component 22 continues to receive the correction image 32 to monitor whether the image 30 is the clearest state. The correction image 32 is present at least in the two of the plurality images 30, and the two correction images 32 are defined as the previous correction image 32 (present at time t) in a previous image and the subsequent correction image 32 (present at time t+1) in a subsequent image, respectively. In practical, it is done by disposing (or inserting) the correction image 32 in some of the plurality of images 30. The processor 20 will re-control the lens driver 16 to adjust the focal length of the projection lens 14 only the reduced value of the luminance contract value of the subsequent correction image 32 with respective to the luminance contract value of the previous correction image 32 is greater than a threshold; wherein the threshold can be 5% of the maximum luminance contract value, but the invention is not limited thereto.

The adjustment of the focal length of the projection lens 14 can be divided into a coarse adjustment phase and a fine adjustment phase. According to the different brand or structure, the projection lens 14 may be moved either forward or backward first for the focal length adjustment, and the invention does not limit the direction that the projection lens 14 is moved for the focal length adjustment. In the coarse adjustment phase, the projection lens 14 is moved in a direction (e.g., the forward direction) and relatively sharply or quickly, and meanwhile the luminance contrast value will gradually increase. When the luminance contrast value suddenly becomes smaller, the coarse adjustment phase is ended and the fine adjustment phase is entered. In the fine adjustment phase, the projection lens 14 is moved in a direction (e.g., the backward direction) opposite to that in the coarse adjustment phase and slowly than that in the coarse adjustment phase, and meanwhile the luminance contrast value gradually increases again. When the luminance contrast value suddenly becomes smaller again, the projection lens 14 is moved in a direction (e.g., the forward direction) opposite to the previous direction to one minimum unit of the mechanism movement capability, thereby completing the adjustment of focal length or the dynamic adjustment of focal length when the out-of-focus occurs during the image displaying. In the embodiment, a stepping motor (not shown) of the lens driver 16 controls the projection lens 14 to move 10 steps in the coarse adjustment phase, and one step in the fine adjustment phase, but the invention is not limited thereto.

According to FIG. 1, the invention further provides an autofocus system 18 disposed in the projector 10. The projector 10 further includes the projection lens 14, the light valve 12 and the lens driver 16. The light valve 12 is adapted to generate at least one image 30. The projection lens 14 is adapted to project the image 30. The projection lens 14 has a focal length, and the focal length of the projection lens 14 can be adjusted by the lens driver 16. The details of the projection lens 14, the light valve 12 and the lens driver 16 have been described above, and no redundant detail is to be given herein.

The autofocus system 18 includes the processor 20, the image sensing component 22 and the image signal processor 24. The processor 20 is electrically connected to the light valve 12 and the lens driver 16. The processor 20 is adapted to control the light valve 12 to add the correction image 32 into the image 30. The image sensing unit 22 is disposed towards the projected image 30 and adapted to capture the correction image 32.

The image signal processor 24 is electrically connected to the image sensing component 22 and the processor 20. The image signal processor 24 is adapted to capture the luminance contrast value of the correction image 32. The processor 20 is adapted to control the projection lens 16 to adjust the focal length of the projection lens 14 according to the luminance contrast value. The luminance contrast value changes with the adjustment of the focal length of the projection lens 14; therefore, when the maximum luminance contrast value is found, it is indicated that the focus of the projection lens 14 is successful and the image 30 is the clearest state. The details of the processor 20, the image sensing component 22 and the image signal processor 24 have been described above, and no redundant detail is to be given herein.

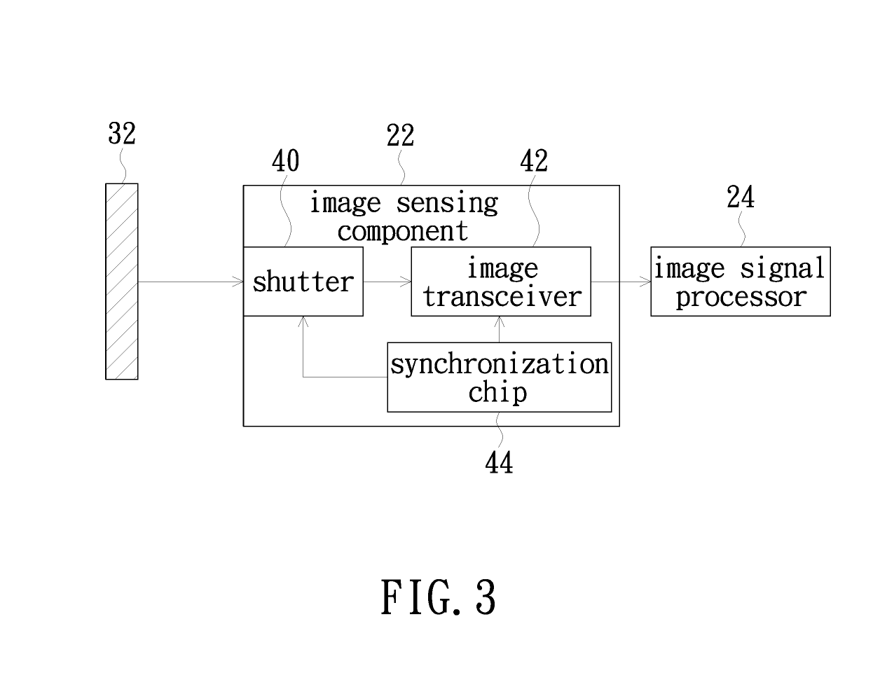

Referring to FIG. 3, which is a schematic view of a structure of the image sensing component 22 performing a synchronization operation in accordance with the invention. As shown, the image sensing component 22 of the embodiment includes a shutter 40, an image transceiver 42 and a synchronization chip 44. The shutter 40 is disposed between the image transceiver 42 and the correction image 32. The shutter 40 is adapted to be turned on or off to control whether allowing a light to pass therethrough; that is, the shutter 40 is adapted to control whether the image transceiver 42 can capture the light of the correction image 32. The shutter 40 is electrically connected to the synchronization chip 44, and the synchronization chip 44 is electrically connected to the image transceiver 42. While the shutter 40 is turned on, the synchronization chip 44 activates the image transceiver 42 to capture the correction image 32. In addition, the image transceiver 42 of the image sensing component 22 may generate the luminance parameter value corresponding to the correction image 32. In addition, the synchronization chip 44 may be electrically connected to the processor 20 (not shown). The processor 20 is adapted to control the light valve 12 to additionally add the correction image 32 into the image 30. Therefore, displaying the correction image 32 on the projection surface 34, turning on the shutter 40 and activating the image transceiver 42 to capture the correction image 32 in the image 30 can be completed within the same time substantially.

In addition, the image sensing component 22 may be one image transceiver 42, which can continuously capture the correction image 32.

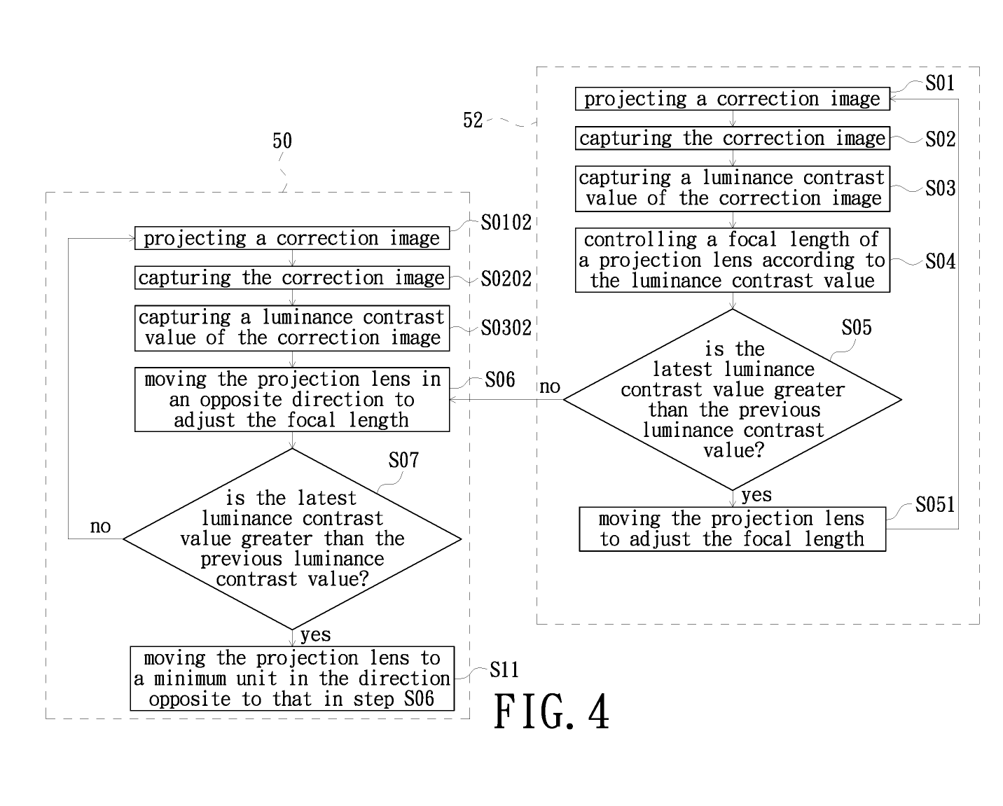

The invention also relates to an autofocus method for the projector 10. The autofocus method for the projector 10 of the invention can be divided into an autofocus when the projector 10 is being turned on and a re-focus when an out-of-focus is monitored by the turned-on projector 10. Referring to FIG. 4, which is a flow chart of an autofocus in an autofocus method in accordance with the invention when a projector is being turned on. The projection lens 14 of the projector 10 can project a plurality of images 30, and only a part of the image 30 includes the correction image 32 or the correction image 32 is inserted in the plurality of image images 30. The projection lens 14 has a focal length. The autofocus method of the embodiment includes the following steps.

First, step 1 (S01): entering a coarse adjustment phase 50 and projecting the correction image 32.

Thereafter, step 2 (S02): configuring the image sensing component 22 to capture the correction image 32.

Thereafter, step 3 (S03): capturing the luminance contrast value of the correction image 32. That is, the image signal processor 24 receives the luminance parameter value provided by the image sensing component 22, and the image signal processor 24 appropriately generates the luminance contrast value corresponding to the luminance parameter value by a calculation method; however, the invention is not limited thereto. The following description is based on the luminance contrast value.

Thereafter, step 4 (S04): configuring the processor 20 to control the focal length of the projection lens 14 according to the luminance contrast value. That is, the forward/backward movement distance of the projection lens 14 is adjusted. The luminance contrast value changes with the focal length of the projection lens 14, and accordingly, the clarity degree of the image 30 is adjusted.

Thereafter, step 5 (S05): configuring the processor 20 to compare the latest luminance contrast value with the previous luminance contrast value to determine whether the latest luminance contrast value is greater than the previous luminance contrast value. If the determination in step 5 (S05) is YES, then step 5-1 (S051): moving the projection lens 14 to adjust the focal length thereof and continuously performing step 1 (step S01) to step 5-1 (S051) to move the projection lens 14 in the same direction. Alternatively, if the determination in step 5 (S05) is NO, a fine adjustment phase 52 is entered and step 6 (S06) is performed. The purpose of step 6 (S06) and thereafter is to find the maximum luminance contrast value, and it is indicated that the image 30 is in the clearest state when the maximum luminance contrast value is found.

Thereafter, step 6 (S06): moving the projection lens 14 in an opposite direction to adjust the focal length thereof. In step 6 (S06) and thereafter, the speed or amplitude or number of steps of the moving of projection lens 14 is smaller than that before step 6 (S06).

Thereafter, step 7 (S07): comparing the luminance contrast value with the previous luminance contrast value to determine whether the latest luminance contrast value is greater than the previous luminance contrast value. If the determination in step 7 (S07) is NO, then step 8 (S0102), step 9 (S0202), step 10 (S0302), step 6 (S06) and step 7 (S07) are performed in sequence. Alternatively, if the determination in step 7 (S07) is YES, step 11 (S11) is performed and will be described as follow.

Thereafter, step 8 (S0102): similar to step 1 (S01).

Thereafter, step 9 (S0202): similar to step 2 (S02).

Thereafter, step 10 (S0302): similar to step 3 (S03).

Thereafter, step 11 (S11): moving the projection lens 14 to a minimum unit in the direction opposite to that in step 6 (S06). At this point, it is determined that the maximum luminance contrast value is found and it is indicated that the correction image 32 is the clearest and the image 30 is in the clearest state.

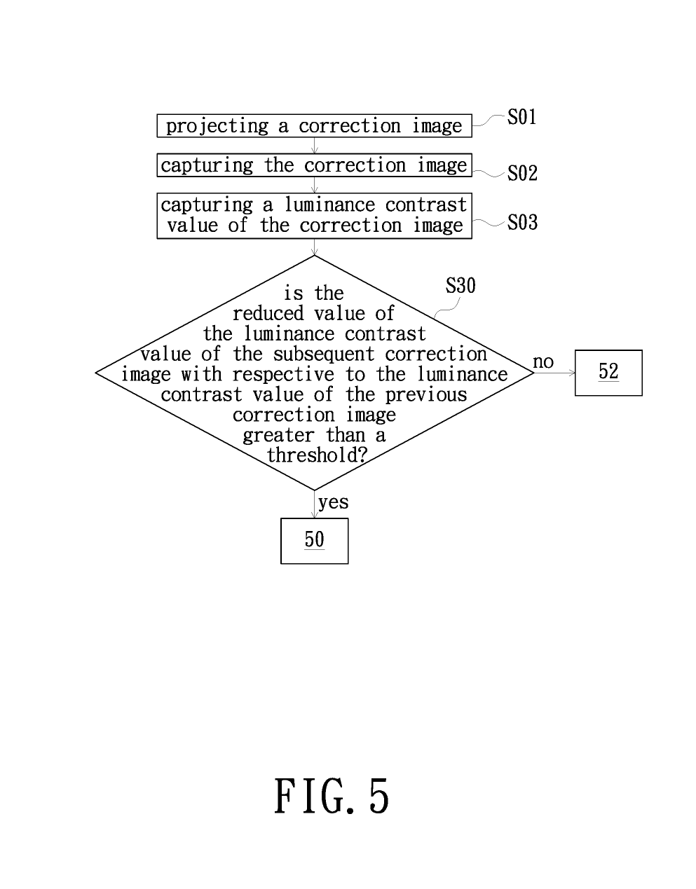

The process of FIG. 4 is ended once it is determined that the image 30 is in the clearest state. Then, the projector 10 automatically enters the process of monitoring out-of-focus and re-focusing. The temperature of the projector 10 may increase when the projector 10 is continuously used, thus, the lenses 1402 of the projection lens 14 may be affected by the high temperature and have an out-of-focus; as a result, the image 30 may have a poor clarity. FIG. 5 is a flow chart of monitoring out-of-focus and re-focusing in the autofocus method in accordance with the invention after the projector is turned on. In the process of FIG. 5, steps 1 (S01), step 2 (S02), step 3 (S03) and step 12 (S30) are performed in sequence, the correction image 32 is added into a part of the continuously-displayed images 30, and the correction image 32 is captured by the image sensing component 22. Step 12 (S30): determining whether the reduced value of the luminance contract value of the subsequent correction image 32 with respective to the luminance contract value of the previous correction image 32 is greater than a threshold; wherein the difference between the luminance parameter value of the subsequent correction image 32 and the luminance parameter value of the previous correction image 32 is not equal to zero.

Thereafter, if the determination in step 12 (step S30) is NO, that is, the reduced value of the luminance parameter value of the subsequent correction image 32 with respective to the luminance parameter value of the previous correction image 32 is still smaller than the threshold, it is indicated that the out-of-focus is caused by the heat affecting the lenses 1042. Thus, the fine adjustment phase 52 as described in FIG. 4 is entered and step 6 (S06) is performed, and no redundant detail is to be given herein. The purpose of step 6 (S06) and thereafter is to find the maximum luminance contrast value, and it is indicated that the image 30 is in the clearest state once the maximum luminance contrast value is founded.

Alternatively, if the determination in step 12 (step S30) is YES, that is, the reduced value of the luminance parameter value of the subsequent correction image 32 with respective to the luminance parameter value of the previous correction image 32 is greater than the threshold, it is indicated that the distance between the projector 10 and the projection surface 34 is relatively large. Thus, the coarse adjustment phase 50 as described in FIG. 4 is entered and step 1 (S01) to step 5-1 (S051) are performed in sequence. Specifically, if the determination in step 5 (505) is NO, then the fine adjustment phase 52 is entered to find the maximum luminance contrast value, and no redundant detail is to be given herein.

The threshold described in step 12 (S30) may be a preset value and stored in a memory of the processor 20. The threshold may be an ideal value defined and tested by experiments, or 5% of the luminance contrast value of the previous correction image 32 or 5% of the maximum luminance contrast value. However, it is understood that the threshold is greater than a change in the luminance contrast value caused by the tolerance of the lenses 1402.

In summary, since the additionally-disposed image sensing component 22 is employed to capture the correction image 32 in the image 30, therefore, the projector 10, the autofocus system 18 in the projector 10 and the autofocus method for the projector 10 of the invention can solve the out-of focus problem caused by lenses having thermal expansion and contraction due to the increased temperature in the conventional projector adopting the distance measuring principle for the autofocus. In addition, since the projector 10 can continuously perform the autofocus during the operation, the projector 10 will not have out-of-focus no matter the change of temperature.

Further, the projector 10 of the invention can automatically perform autofocus after the projector 10 is turned on, constantly automatically monitor out-of-focus and re-focusing when the out-of-focus is about or temporarily occurring during the operation. Therefore, the projector 10 of the invention can quickly automatically perform autofocus once the out-of-focus occurs caused by increased temperature, vibration or movement. As a result, the users do not need to worry about the out-of-focus of the projector 10.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. An autofocus system disposed in a projector, the projector further comprising a projection lens, a light valve and a lens driver, the light valve being adapted to generate at least one image, the projection lens being adapted to project the image, the projection lens having a focal length, the lens driver being adapted to adjust the focal length of the projection lens, and the autofocus system comprising:
a processor, electrically connected to the light valve and the lens driver, adapted to control the light valve to add a correction image into the image;
an image sensing component, disposed toward the image and adapted to capture the correction image; and
an image signal processor, electrically connected to the image sensing component and the processor, adapted to receive a luminance parameter value of the correction image from the image sensing component, wherein the processor controls the lens driver to adjust the focal length of the projection lens according to the luminance parameter value, and the processor adjusts the focal length of the projection lens and changes the luminance parameter value to find a maximum of the luminance parameter value.

2. The autofocus system according to claim 1, wherein when the projection lens projects a plurality of the images, the processor determines the focal length and stops controlling the lens driver, the correction image is present in at least two of the plurality of images, and the two correction images are defined as a previous correction image in a previous image and a subsequent correction image in a subsequent image respectively, wherein when a reduced value of the luminance parameter value of the subsequent correction image with respective to the luminance parameter value of the previous correction image is greater than a threshold, the processor re-controls the lens driver to adjust the focal length of the projection lens.

3. The autofocus system according to claim 1, wherein the image sensing component comprises: a shutter, an image transceiver and a synchronization chip, the shutter is disposed between the image transceiver and the correction image projected by the projection lens, the shutter is electrically connected to the synchronization chip, the synchronization chip is electrically connected to the image transceiver, wherein the synchronization chip is adapted to activate the image transceiver to capture the correction image when the shutter is turned on.

4. A projector, comprising:
a light valve, adapted to generate at least one image;
a projection lens, adapted to project the image and having a focal length;
a lens driver, coupled to the projection lens and adapted to adjust the focal length of the projection lens; and
an autofocus system, comprising:
a processor, electrically connected to the light valve and the lens driver, adapted to control the light valve to add a correction image into the image;
an image sensing component, disposed toward the image and adapted to capture the correction image; and
an image signal processor, electrically connected to the image sensing component and the processor, adapted to receive a luminance parameter value of the correction image from the image sensing component, wherein the processor controls the lens driver to adjust the focal length of the projection lens according to the luminance parameter value, and the processor adjusts the focal length of the projection lens and changes the luminance parameter value to find a maximum of the luminance parameter value.

5. The projector according to claim 4, wherein when the projection lens projects a plurality of the images, the processor determines the focal length and stops controlling the lens driver, the correction image is present in at least two of the plurality of images, and the two correction images are defined as a previous correction image in a previous image and a subsequent correction image in a subsequent image respectively, wherein when a reduced value of the luminance parameter value of the subsequent correction image with respective to the luminance parameter value of the previous correction image is greater than a threshold, the processor re-controls the lens driver to adjust the focal length of the projection lens.

6. The projector according to claim 4, wherein the image sensing component comprises a shutter, an image transceiver and a synchronization chip, the shutter is disposed between the image transceiver and the correction image projected by the projection lens, the shutter is electrically connected to the synchronization chip, the synchronization chip is electrically connected to the image transceiver, wherein the synchronization chip is adapted to activate the image transceiver to capture the correction image when the shutter is turned on.

7. The projector according to claim 5, further comprising a memory, wherein the memory is electrically connected to the processor and adapted to store the luminance parameter value provided from the image signal processor, a maximum of the luminance parameter value or the threshold.

8. An autofocus method for a projector, a projection lens of the projector projects at least projecting one image, the image comprising a correction image, the projection lens having a focal length, and the autofocus method comprising:
projecting the correction image;
capturing the correction image;
capturing a luminance parameter value of the correction image;
controlling the focal length of the projection lens according to the luminance parameter value, wherein a process of controlling the focal length of the projection lens according to the luminance parameter value comprises a coarse adjustment phase and a fine adjustment phase, and the luminance parameter value changes with the adjustment of the focal length of the projection lens; and
finding a maximum of the luminance parameter value.

9. The autofocus method according to claim 8, further comprising:
determining whether a reduced value of the luminance parameter value of a subsequent correction image with respective to the luminance parameter value of a previous correction image is greater than a threshold, wherein the correction image is present in at least two of the plurality of images, and the two correction images are defined as the previous correction image and the subsequent correction image, respectively.

10. The autofocus method according to claim 9, further comprising:
entering the fine adjustment phase when it is determined that the reduced value of the luminance parameter value of the subsequent correction image with respective to the luminance parameter value of the previous correction image is smaller than the threshold.

11. The autofocus method according to claim 9, further comprising:
entering the coarse adjustment phase when it is determined that the reduced value of the luminance parameter value of the subsequent correction image with respective to the luminance parameter value of the previous correction image is greater than the threshold.
